(19) United States
(12) Patent Application Publication
(10) Pub. No.: US 2010/0117378 A1
(43) Pub. Date: May 13, 2010

(54) DOORLOCK DEVICE FOR AN ELECTRIC HOME APPLIANCE

(76) Inventors: Sang Won Seo, Jeollabuk-do (KR); Sang Baek Kim, Jeollabuk-do (KR); Hyeon Sik Kim, Seoul (KR); Min Seob Jin, Jeollabuk-do (KR)

Correspondence Address: CHRISTOPHER PAUL MITCHELL, 888 16TH ST., NW, SUITE 800, WASHINGTON, DC, 20006, US

(21) Appl. No.: 12/438,947

(22) PCT Filed: Dec. 31, 2007
(86) PCT No.: PCT/KR07/07007

§ 371 Date: Dec. 29, 2009

(30) Foreign Application Priority Data
Apr. 25, 2007 (KR) 10-2007-0040580

(51) Int. Cl. E05C 1/08; E05B 65/52

(52) U.S. Cl. 292/163

(57) ABSTRACT

The doorlock device according to the present invention comprises a latch which is attached to a door for closing it, a cover including a latch opening and a latch slider which is elastically supported due to the insert of the latch, a locker which restricts the latch slider, a slider which moves the locker up and down, a solenoid which pushes a push cam in accordance with control signal to rotate a rotation cam so that the slider is moved left and right, a housing including the locker, the solenoid and a contact point part in which electric signal is inputted, a locker withdrawal part which forcibly withdraws the protruded locker by the operation of a torsion spring which is elastically supported, thereby separating a movable plate from a fixed plate upon abnormal withdrawal of the latch. According to the doorlock device of the present invention, the push cam operated by the solenoid causes the eccentric part of the rotation part to move the locker vertically, thus resulting in the latch slider being held or released by the locker. This bring about an effect that the structure of the doorlock device can be simplified, so that it becomes easier and cheaper to manufacture the doorlock device. Further, it is possible to provide a doorlock device whose operation credibility is improved. Still further, it is possible to provide a doorlock device which stops the operation of the electric home appliance when the latch is withdrawn abnormally.

### TECHNICAL FIELD

The present invention relates to a doorlock device for closing and opening a door of an electric home appliance, and more specifically to a doorlock device wherein a push cam is moved by a solenoid which is operated by an input of electrical control signal to rotate a rotation cam in predefined direction, thereby moving a slider in left and right direction which restricts a latch slider and a locker by its horizontal movement and separates a movable plate from a fixed plate upon abnormal withdrawal of the latch, which immediately stops the operation of the electric home appliance.

### BACKGROUND ART

Electric home appliance such as laundry machine, dish washing machine, drying machine, kitchen stove, microwave oven and etc is provided with a doorlock device for opening a door of such product only under specified situation. That is, safety regarding home appliance is pursued by having the door of home appliance opened only under specified situation, which needs that the door of home appliance should be kept closed when the home appliance is in use.

A number of doorlock devices are already known, one of which is disclosed in the title of ‘device for closing and releasing a door of electric home appliance’ in the U.S. Pat. No. 6,334,637 B1 wherein an inserted latch is inhibited from sliding by rotating two continuous toothed wheels in accordance with the actuation of solenoid, thereby achieving latch restriction. That is, the latch restriction mechanism in the above device is achieved by transmitting reciprocating motion of the solenoid to the toothed wheels, such that the locker is moved which is engaged to the teeth of the toothed wheels.

### DISCLOSURE OF INVENTION

### Technical Problem

However, since in the above doorlock device the teeth of a toothed wheel is engaged with the teeth of the other two toothed wheels such that the doorlock device is operated by the solenoid, entire volume of the doorlock device is increased due to the toothed wheels, and further, said locker often malfunctions in connection with the rotation of the toothed wheels, which leads to low operation credibility of the entire device. Technical Solution

The purpose of the present invention is to provide a doorlock device which can address the above problems, wherein a push cam operated by a solenoid causes an eccentric part of a rotation part to move a locker vertically, thus resulting in a latch slider being held by the locker, so that the structure of the doorlock device can be simplified, which makes it possible to manufacture the doorlock device more easily and cheaply as well as to improve the operation credibility.

Another purpose of the present invention is to provide a doorlock device which stops the operation of the electric home appliance as soon as the latch is withdrawn abnormally.

The doorlock device according to the present invention comprises a latch which is attached to a door for closing it, a cover including a latch opening and a latch slider which is elastically supported due to the insert of the latch, a locker which restricts the latch slider, a slider which moves the locker up and down, a solenoid which pushes a push cam in accordance with control signal to rotate a rotation cam so that the slider is moved left and right, a housing including the locker, the solenoid and a contact point part in which electric signal is inputted, a locker withdrawal part which forcibly withdraws the protruded locker by operation of a torsion spring which is elastically supported, thereby separating a movable plate from a fixed plate upon abnormal withdrawal of the latch.

### Advantageous Effects

According to the doorlock device of the present invention, the push cam operated by the solenoid causes the eccentric part of the rotation part to move the locker vertically, thus resulting in the latch slider being held or released by the locker. This bring about an effect that the structure of the doorlock device can be simplified, so that it becomes easier and cheaper to manufacture the doorlock device. Further, it is possible to provide a doorlock device whose operation credibility is improved. Still further, it is possible to provide a doorlock device which stops the operation of the electric home appliance as soon as the latch is withdrawn abnormally.

### BRIEF DESCRIPTION OF THE DRAWINGS

FIG. 1 shows perspective view of a doorlock device according to the present invention.

FIG. 2 shows perspective view of a disassembled doorlock device according to the present invention.

FIG. 3 shows perspective view of a disassembled doorlock device according to the present invention.

FIG. 4 shows perspective view of a push cam and a rotation cam according to the present invention.

FIG. 5 shows cross-sectional view of a solenoid and a cam housing according to the present invention.

FIG. 6 shows plan view of the doorlock device according to the present invention.

FIG. 7 shows cross-sectional view of A-A′ plane of FIG. 6 before a latch is inserted.

FIG. 8 shows cross-sectional view of A-A′ plane of FIG. 6 after the latch is inserted.

FIG. 9 shows cross-sectional view of A-A′ plane of FIG. 6 when locking is activated.

FIG. 10 shows perspective view of FIG. 8.

FIG. 11 shows perspective view of FIG. 9.

FIG. 12 shows perspective view of a locker withdrawal part of another embodiment according to the present invention.

FIG. 13 shows perspective operational view of the locker withdrawal part when the latch of FIG. 12 is inserted.

FIG. 14 shows perspective operational view of the locker withdrawal part when the latch of FIG. 12 is forcibly withdrawn.

### REFERENCE NUMERALS FOR THE PRIMARY CONSTITUTIONAL ELEMENTS IN THE DRAWINGS

100 . . . latch

200 . . . housing

300 . . . cover

310 . . . latch opening

301 . . . locker opening

400 . . . latch slider

410 . . . latch slider spring

420 . . . latch insert opening

421 . . . latch support

430 . . . latch holder

440 . . . fixing recess

500 . . . contact point part

510 . . . movable plate

520 . . . fixed plate

511 . . . locker withdrawal part

551,560 . . . PTC

600 . . . solenoid

610 . . . solenoid plunger

620 . . . bobbin

630 . . . solenoid case

700 . . . cam housing

710 . . . push cam

720 . . . rotation cam

730 . . . rotation cam spring

750 . . . slider

751 . . . slider spring

800 . . . locker

810 . . . movable plate insert

900,901 . . . locker withdrawal part

910,911 . . . protrusion

920 . . . locker engagement part

921 . . . rib engagement part

930,931 . . . hinge hole

940 . . . fixer

### BEST MODE FOR CARRYING OUT THE INVENTION

One embodiment of the present invention is to be described in detail with reference to the attached drawings.

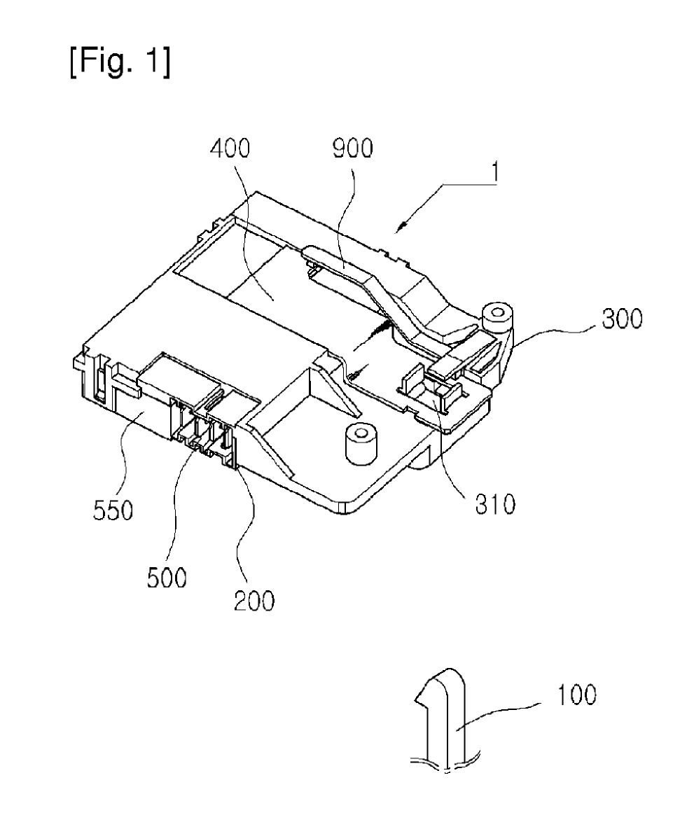

FIG. 1 shows perspective view of the doorlock device in accordance with the present invention.

As to outer constitution, the doorlock device comprises a housing 200 including PTC receiving part 500 which receives PTC(positive temperature coefficient) and switch contact point part 500, a cover 300 combined with the housing and including a latch opening 310 through which a latch is inserted, a latch slide part 400 which is combined with the upper part of the cover to be pushed by the inserted latch and includes a latch slider spring 410 for elastically supporting the latch slider, and a locker withdrawal part 900 which separates a movable plate and a fixed plate by forcibly withdrawing the protruded locker 800 through operation of a torsion spring which is elastically supported upon abnormal withdrawal of the latch.

Hereinafter the inner constitution of the doorlock device is described in detail.

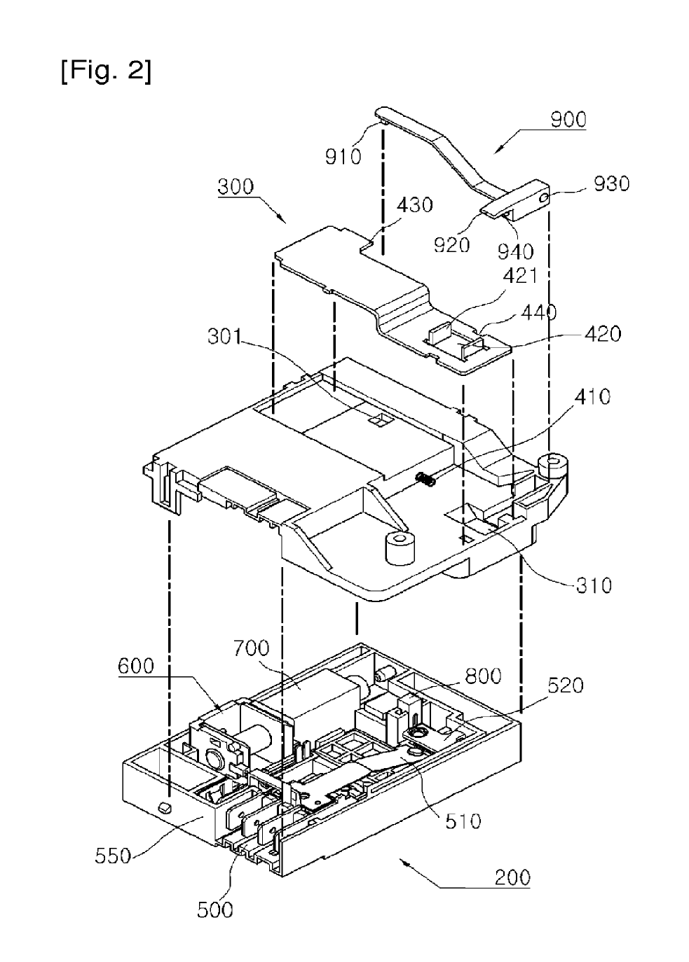

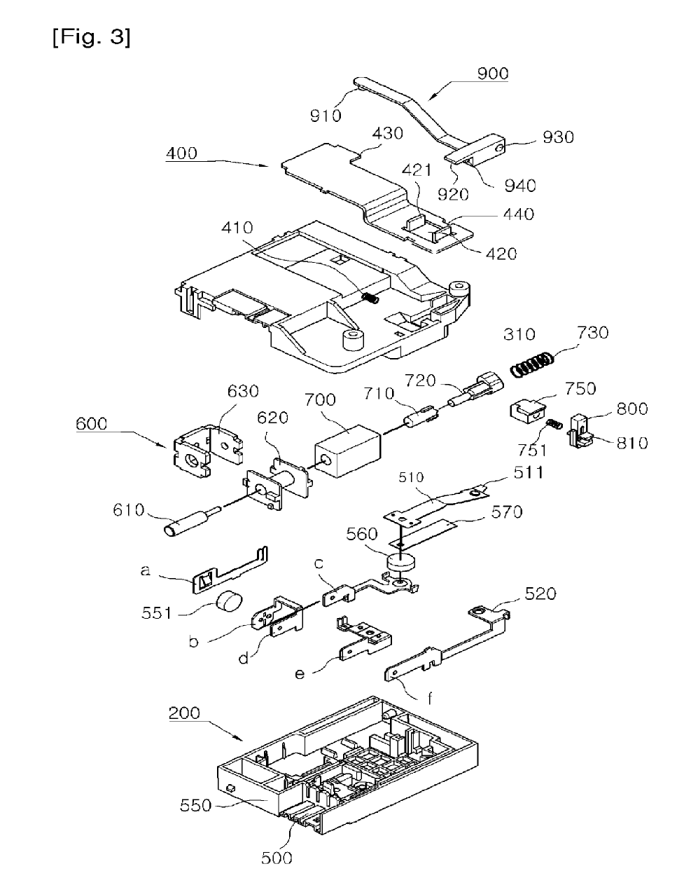

FIGS. 2 and 3 show perspective views of the disassembled doorlock device of the present invention.

The doorlock device of the present invention comprises a housing 200 in which PCT receiving part 550, contact point part 500, solenoid 600, a cam housing 700 moved by the solenoid and a locker moved by the cam housing 700 are provided; a cover 300 which is combined with the housing 200, includes a latch opening 310 through which a latch 100 is inserted and locker opening 301 through which the locker 800 is vertically moved in and out; a latch slider 400 which is pushed by the inserted latch 100 and elastically supported by a latch slider spring 410 provided on the upper surface of the cover 300. Further, in the doorlock device are provided a locker withdrawal part 900 which is combined with the cover through hinge-joint and is rotated by the insert of the latch 100 about the hinge-joint, a torsion spring which elastically supports the locker withdrawal part 900 against the direction in which the latch 100 is inserted, and a protrusion 910 in the upper area of the locker for forcibly withdrawing the locker 800 through the operation of the torsion spring upon the abnormal withdrawal of the latch.

An ordinary-skilled person of the art could easily design the constitution of the torsion spring, which elastically supports the locker withdrawal part 900, and thus it is not shown in the drawings.

In the PTC receiving part 550, solenoid contact points (a) and (b) are arranged and PTC 551 is placed between the solenoid contact points (a) and (b).

In the contact point, part 500, bimetal contact point (c), the other contact point (d) of the solenoid, contact point (e) and fixed plate contact point (f) is arranged, respectively.

In the one end of the bimetal contact point (c), the bimetal 570 and movable plate 510 is arranged, respectively, and PTC 560 is placed between the movable plate 510 and the bimetal 560.

The PTCs 551,560 is a semiconductor which conducts electricity below predestined temperature and cut the electricity when heated over predestined temperature due to drastic increase of resistance, respectively, and thus functions as a switch which is short-circuited when electrical flow increases drastically.

The solenoid 600, which is connected at the solenoid contact points (a) and (b) and is activated by the contact point (e), comprises a solenoid case 630 and a solenoid plunger 610 placed in the center of a bobbin 620, upon which electric wire is wound.

The one end of the solenoid plunger 610 is received in a cam housing 700, in which a push cam 710 and a rotation cam 720 which rotates according to the reciprocating movement of the push cam is placed, respectively.

On the one end of the rotation cam 720, an eccentric part 721 is formed eccentrically relative to shaft axis of the rotation cam 720 and a rotation cam spring 720 is provided to elastically support the push cam and the rotation cam. A slider 750 is provided to engage the outer contacting surface of the eccentric part 721.

A slider spring 751 is provided to have the slider 750 contact with the eccentric part 751 of the rotation cam 720 at any time and the slider 750 is arranged in oblique angle with a locker 800.

In the locker 800, movable plate insert 810 is provided, in which the locker withdrawal part 511 of the movable plate is inserted and placed.

A cover 300 is placed upon the upper part of the housing 200 and combined with the housing to secure the above-described components in their position, in which a locker opening 301 through which the locker 800 provided in the housing 200 is moved in and out in accordance with its longitudinal movement. In the upper part of the cover 300, a latch slider 400 is placed.

The latch slider 400 comprises a latch insert opening 420 which is in communication with a latch opening 310 through which the latch 100 is inserted, a locker holder 430 which is pushed by the insert of the latch 100 and opens the locker opening 301 thereby the locker 800 protruding to cause the restriction of the latch slider 400, and a latch slider spring 410 which restores the moved latch slider 400 in its initial position in accordance with the move-in of the locker 800 and the move-out of the latch 100.

A locker withdrawal part 900 is also provided which is combined with the cover 300 through a hinge-joint, thereby the locker withdrawal part 900 rotating by the insert of the latch 100 about the hinge-joint. The locker withdrawal part 900 is elastically supported against the insert of the latch 100 by a torsion spring and includes the protrusion 910 in the upper area of the locker 800 for forcibly withdrawing the latch 800 by the torsion spring upon abnormal withdrawal of the latch.

A latch slider fixer 940 is provided on the locker withdrawal part 900 and a fixing recess 440 is provided in the latch slider 400 which engages with the latch slider fixer 940 such that the latch slider 400 is fixed by the locker withdrawal part 900 against normal withdrawal of the latch 100.

Now, the above-mentioned push cam and the rotation cam are explained in detail, which replace the constitutional element of the toothed wheel in the prior art.

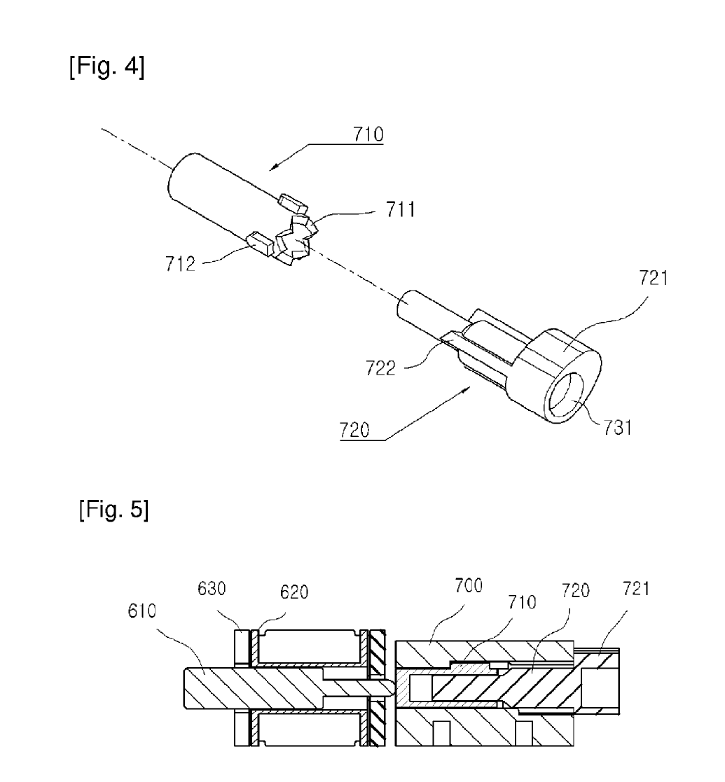

FIG. 4 shows the perspective view of the push cam and the rotation cam.

The push cam 710, hollowly shaped, includes protrusion 712 and toothed part 711, and the rotation cam 720 includes oblique angle parts 722 and an eccentric part 721 which is formed eccentric relative to the oblique angle part.

Further, the rotation cam 720 is elastically pushed by a rotation cam spring 730 which is provided on the inner surface of the housing 200, so that the rotation cam 720 engages with the push cam 710.

The oblique angle parts 722 on the rotation cam 720 are arranged in 120° angular distribution along the circumference of the rotation cam 720, hence the number of them being 3.

Therefore, the solenoid plunger 610 pushes the push cam 710 in the cam housing 700 in response to the control signal of the solenoid 600, so that the push cam 710 pushes the rotation cam 720 and rotates it by 120° simultaneously.

An ordinary-skilled person of the art could modify the rotation direction of the rotation cam 720 caused by the pushing of the push cam 710 appropriately according to the embodiment.

The above-described constitution is described in cross-sectional view hereinafter.

FIG. 5 shows cross-sectional view of the solenoid and cam housing 700 according to the present invention.

The solenoid 600 comprises the solenoid case 630 and the bobbin 620 whereon electric wire is wound and in which the solenoid plunger 610 is placed.

When electric signal is inputted to the solenoid 600, the solenoid plunger 610 pushes the push cam 710 placed in the cam housing 700. Then, the push cam 710 pushes the rotation cam 720 while rotating it with its toothed part 711 and the protrusion 712 and the oblique angle part 722 of the rotation cam 720.

Now, the operation of the above-described constitution is described.

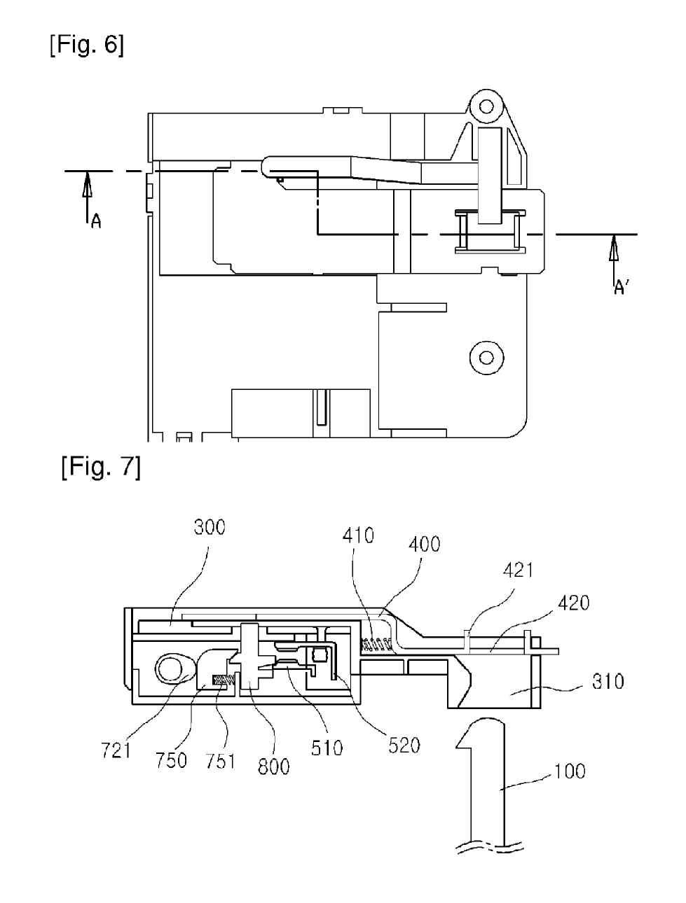

FIG. 6 shows a plane view of the doorlock device of the present invention, while FIGS. 7, 8 and 9, each showing the A-A′ plane of FIG. 6, shows cross-sectional view before the latch is inserted, cross-sectional view when the latch is inserted, and cross-sectional view when locking is activated, respectively.

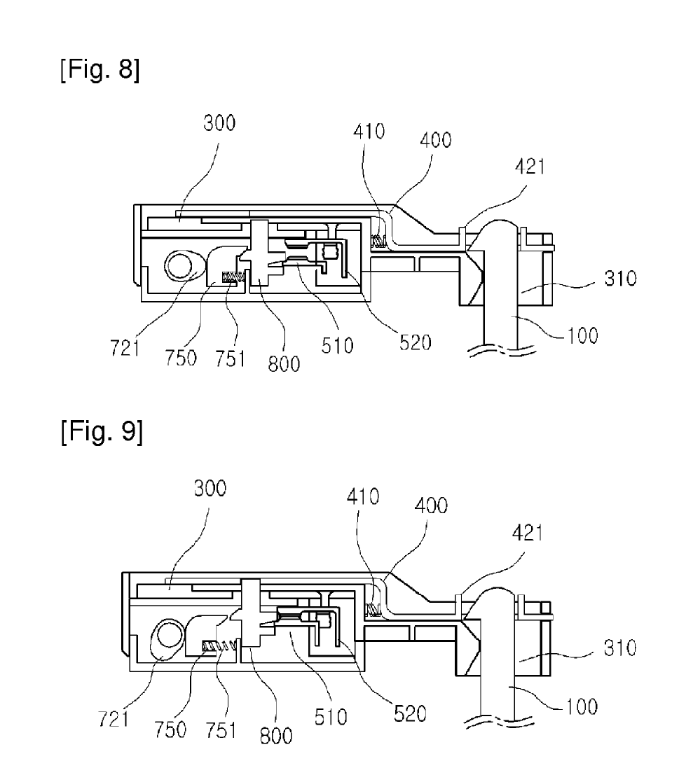

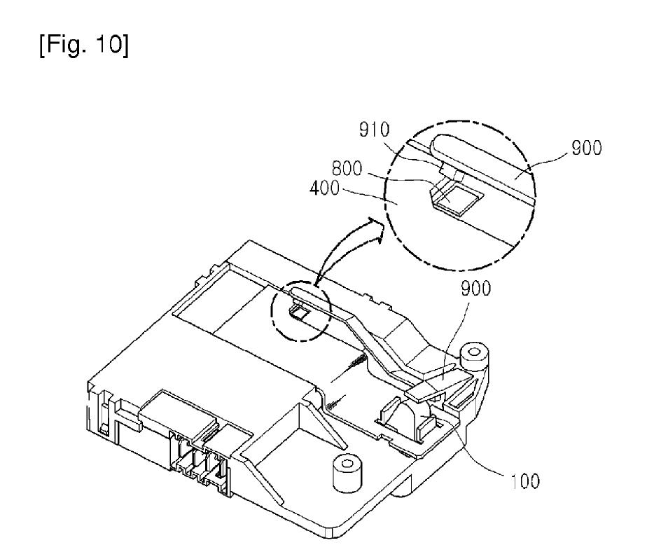

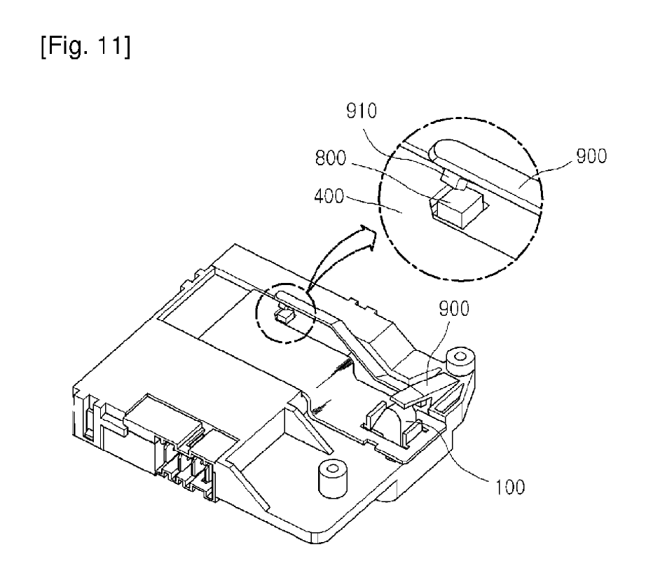

Further, FIGS. 10 and 11 shows the perspective view of the FIGS. 8 and 9, respectively.

Although the locker withdrawal part 900 is not shown in FIGS. 7, 8 and 9, the ordinary-skilled of the art could easily understand of the operation of the constitution with reference to FIGS. 10 and 11.

In FIG. 7, the crest point of the eccentric part 721 is in engagement with the slider 750. In addition, the slider 750 holds the locker 800, while the latch slider 400 arranged on the cover 300 is elastically supported by the latch slider spring 410.

The latch 100 passes through the latch opening 310 in the cover 300 to be inserted in the latch insert opening 420 in the latch slider 400 by the closing operation of a door(s) (see FIGS. 8 and 10). As the latch 100 is inserted, a holder of the latch 100 comes to in engagement with the latch support 421 in the latch slider 400, thereby pushing the latch slider 400 in the left direction as in the figs. At the same time, as a result of the insert of the latch 100, the locker withdrawal part 900 is rotated due to its engagement with the latch 100 and the latch slider fixer 400 gets out of the fixing recess 440 in the latch slider 400, so that the latch slider 400 is pushed and the protrusion 920 of the locker withdrawal part 900 is displaced above the locker slider 400.

When the latch slider 400 is pushed in the left direction, the locker opening 301 shows up, placed on the cover 300 to pass through the cover 300, where the locker 800 protrudes.

Under the situation where the latch 100 is inserted or the door is closed, in response to the input of the control signal to the solenoid 600, the solenoid plunger 610 pushes the push cam 710 to push and rotate the rotation cam 720 which is in engagement with the push cam 710.

As a result of the rotation of the rotation cam 720, the eccentric part 721 is rotated by 120°, then the slider 750, in engagement with the eccentric part 721, is pushed in the left direction in the figs, along the circumferential surface of the eccentric part 721 by the slider spring 751, so that the locker 800 comes to be in contact only with the locker withdrawal part 511 of the movable plate 510.

Under the above-specified situation, when the electric signal is inputted to the bimetal 570 by pushing a push-button on the electric home appliance, the bimetal 570 moves the movable plate 510 in the upward direction, thereby the locker 800 being moved in the upward direction and protruding above the cover 300 (see FIGS. 9 and 11).

As a result of the protruding of the locker 800 above the cover 300, the latch slider 400 is fixed, and thus the latch 100 cannot be withdrawn from the latch opening 310.

When control signal (electric signal) is inputted to the solenoid 600 under the above-specified situation, the rotation cam 720 is rotated by 120° while the latch 100 is kept in its locked position.

When the second control signal is inputted to the solenoid 600 under the above-specified situation, the rotation cam 720 returns to its initial position pushing the slider 750 with its eccentric part 750, so that the slider 750 pushes the locker 800 downwards, and thus the latch slider 400 comes to be in free-to-move condition.

Now, the locker withdrawal part 900 is described in detail.

Although the door is seldom opened by compulsion, it is necessary to consider this seldom case.

The latch 100 could be withdrawn not only by compulsion due to its wear or release of the holding means which holds the latch, but also by any force opening the door forcibly.

That is to say, abnormal opening of the door often occurs during the use of the electric home appliance, which can result in great danger.

Therefore, it is necessary to forcibly separate the movable plate 510 from the fixed plate 520, so that the operation of the appliance be stopped when the door is abnormally opened during the use of the appliance.

One embodiment of the above-specified constitution is described referring to FIGS. 10 and 11.

As described in the above paragraph, the locker withdrawal part 900 rotated by the insert of the latch 100 is combined with the cover 300 above the latch slider 400 through a hinge-joint and is elastically supported by the torsion spring against the insert direction of the latch 100.

As shown in the figs, the locker withdrawal part 900 which is connected with the cover 300 through hinge hole 930 in the cover 300 and is elastically supported by the torsion spring(not shown in the figs.) against the insert direction of the latch 100, comprises the protrusion 910 which is formed to protrude for the withdrawal of the locker 800 and a latch engagement part 920 which is rotated by the insert of the latch 100, resulting in the displacement of the protrusion 910 from the locker opening 920.

Describing the operation of the above-specified constitution, if the latch 100 is forcibly withdrawn under a situation where the latch 100 is inserted, the latch slider 400 is fixed by the locker 800. In this situation, the locker 800 is kept in its upward protruded position, the movable plate 510 contacts with the fixed plate 910, and the electric home appliance is in. operation. Therefore, it is needed to forcibly separate the movable plate 920 from the fixed plate 910 to stop the operation of the appliance.

As shown in the figs, if the latch 100 is withdrawn abnormally, the locker withdrawal part 900 restores to its initial position and its protrusion 910 strikes on the locker 800, thereby withdrawing the locker 800 into the cover 300. Then, as the locker 800 is withdrawn into the cover 300, it separates the movable plate 510 from the fixed plate 520.

Hence, the electric home appliance comes to stop.

At this time, the latch slide 400 can be held by the protrusion 910 of the locker withdrawal part 900, but it is again held by the latch 400 as the latch 400 is inserted again.

If the latch 100 is withdrawn by normal operation, the latch slide 400 operates first to returns to its initial position, so that the protrusion 910 of the locker withdrawal part 900 comes to in engagement with the upper surface of the latch slider 400.

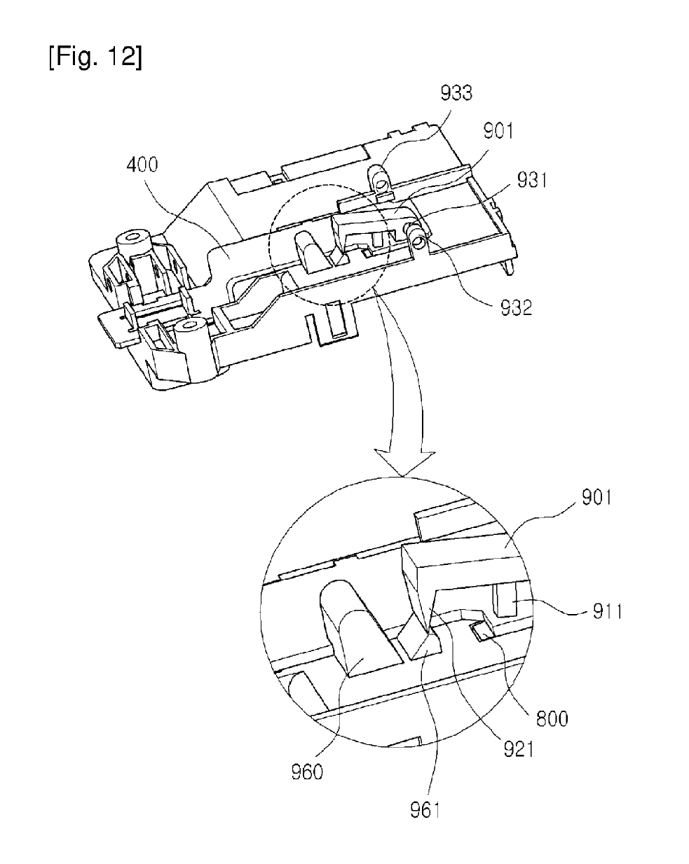

FIGS. 12, 13 and 14 shows perspective view of another embodiment of the locker withdrawal part, perspective view illustrating the operation of the locker withdrawal part of FIG. 12 when the latch is inserted and when the latch is forcibly withdrawn, respectively.

As shown in the figs, the locker withdrawal part 901 is combined with the cover 300 through a hinge-joint in a manner that its hinge joint hole 931 is in communication with hinge joint protrusions 932,933 which are shaped to protrude on the cover 300. Further, the locker withdrawal part 901 comprises in its underpart a rib engagement part 921 which corresponds to a front rib 960 and a rear rib 961 each of which is formed on the latch slider 400 to have a predestined angle, and a protrusion 911 which strikes on the head surface of the locker 800. Further, the locker withdrawal part 901 is elastically supported by a torsion spring, which is not shown in the figs, because an ordinary-skilled person of the art could easily understand its structure and design it.

Now, the operation of the above-described constitution is described.

As mentioned, the front rib 960 and the rear rib 961 is fixed and attached to the latch slider 400 and an angular surface with predestined angle, respectively.

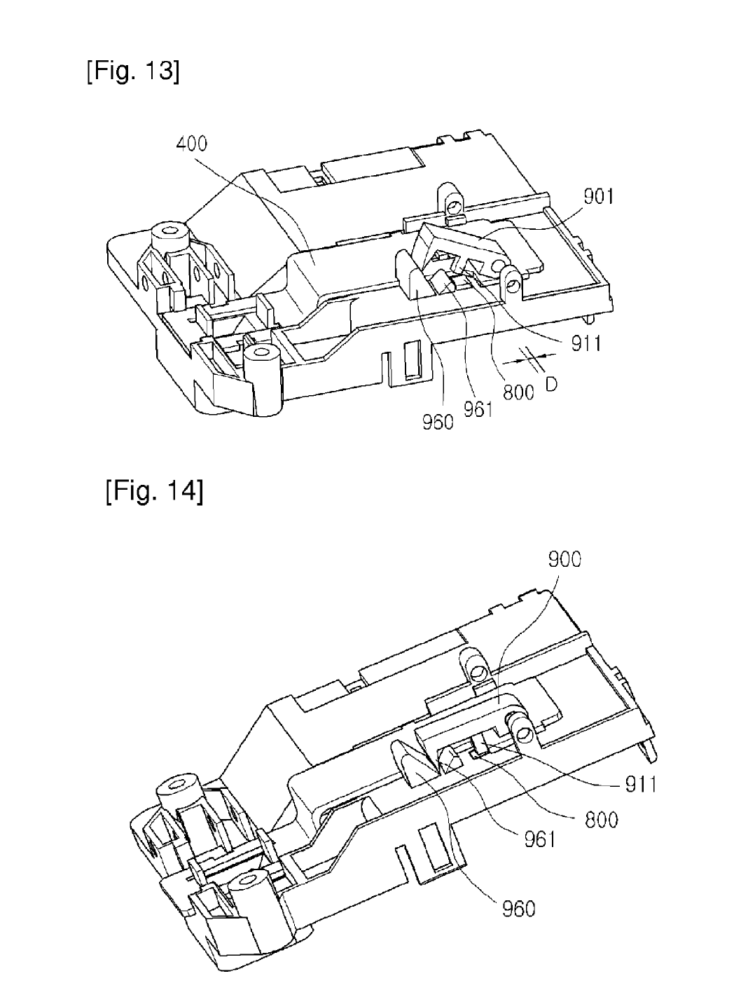

The rib engagement part 921 of the locker withdrawal part 901 slides on the angular surfaces along their respective angle, thereby the locker withdrawal part 901 rotating about the hinge-joint. That is, as the latch 100 is inserted, it pushes the latch slider 400, so that the rib engagement part 921 of the locker withdrawal part 901 slides on the angular surface of the front rib 960 along its angle, thereby the locker withdrawal part 901 being rotated (see FIG. 13).

Under the above-specified situation, when the electric home appliance is operated, the locker 800 protrudes. If the normal control signal is inputted, the locker 800 is restored to its initial position by being withdrawn into the cover, the appliance stops operating, and the latch slider 400 is pushed by the latch slider spring 410, so that the rib engagement part 921 of the locker withdrawal part 901 slides on the angular surface of the rear rib 961 along its angle, thereby the locker withdrawal part 901 being rotated about the hinge-joint.

Further, when the latch 100 is inserted on the input of the normal control signal, the locker opening 301 (see FIG. 3) is spaced from the locker holder 430 (see FIG. 3) by distance D.

In case the latch 100 is forcibly withdrawn on the input of the abnormal control signal, the latch slider 400 is pushed by the latch slider spring 401 and is displaced by the distance D. Thus, the rib engagement part 921 which is in engagement with the front rib 960 is lowered by the torsion spring (not shown in the figs.) and the protrusion 911 strikes on the head surface of the locker 800, so that the movable plate 510 (see FIG. 3) is separated from the fixed plate 520 (see FIG. 3), hence the appliance stops operating,

The rib engagement part 921 of the locker withdrawal part 901 can be formed in another shape, desirably further includes a wheel component which can rotate.

Further, if the rib engagement part 921 includes a rotatable wheel component, the shape of the front rib 960 and the rear rib 961 is to be modified in accordance with the shape of the rib engagement part 921, which of course falls within the scope of the present invention.

Further, the eccentric part in the rotation cam can be formed in a multi-eccentric shape or other shape, not limited to the eccentric part of the rotation cam shown in the figs, and described in the above, which is formed to be eccentric only in one direction.

Therefore, the eccentric part of the rotation cam can have various shape, and thus the scope of the present invention should not be limited or narrowed to the above-described embodiment.

1. A doorlock device for an electric home appliance, comprising: a housing 200 having a PTC receiving part 550, a contact point part 500, a solenoid 600, a cam housing 700 which is operated by the solenoid 600, and a locker 800 which is operated by the cam housing 700; a cover 300 which is combined with the housing 200 and includes a latch opening 300 through which a latch 100 is inserted and on which a locker opening 301 is provided through which a locker 800 vertically moves in and out; and a latch slider 400 which is pushed by the insert of the latch 100 and is elastically supported by a latch slider spring 410 provided on the upper surface of the cover 300, wherein the solenoid 600 includes a solenoid case 630 and a solenoid plunger 610 placed in the center of a bobbin 620 upon which electric wire is wound, the one end of the solenoid plunger 610 being received in the cam housing 700, in which a push cam 710 and a rotation cam 720 rotated by the reciprocating motion of the push cam 710 are placed, and wherein an eccentric part 721 is provided at the one end of the rotation cam 720 which is formed to be eccentric relative to the shaft axis of the rotation cam 720, and a slider 750 is provided to be in engagement with the outer surface of the eccentric part 721.

2. The doorlock device of claim 1, wherein three oblique angle parts 722 are arranged on outer surface of the rotation cam 720 in 120° angular distribution along the circumference of the rotation cam 720, wherein the solenoid plunger 610 pushes the push cam 710 placed in the cam housing 700 in response to the control signal of the solenoid 600, thus the push cam 710 pushing the rotation cam 720 and rotating it by 120° simultaneously.

3. The doorlock device of claim 1, further comprising: a locker withdrawal part 900 which is combined with the cover 300 through a hinge-joint and is rotated by the insert of the latch 100 about the hinge-joint; and a torsion spring for elastically supporting the hinge withdrawal part 900 against the direction in which the latch 100 is inserted, wherein the locker withdrawal part 900 is provided with a protrusion 910 in the upper area of the locker 800 for forcibly withdrawing the locker 800 through the operation of the torsion spring upon the abnormal withdrawal of the latch 100.

4. The doorlock device of claim 3, wherein the locker withdrawal part 900 is provided with a latch slider fixer 940 and the latch slider 400 is provided with a fixing recess 400 which engages with the latch slider fixer 940.

5. The doorlock device of claim 1, further comprising a locker withdrawal part 901 which is combined with the cover 300 through a hinge-joint such that its hinge joint hole 931 is in communication with hinge joint protrusions 932,933 which are shaped to protrude on the cover 300, the locker withdrawal part 901 comprising in its underpart a rib engagement part 921 corresponding to a front rib 960 and a rear rib 961 each of which is formed on the latch slider 400 to have a predestined angle, and a protrusion 911 which strikes on the head surface of the locker 800, the locker withdrawal part 901 being elastically supported by a torsion spring.

6. The doorlock device of claim 5, wherein the rib engagement part 921 further comprising a wheel component which is rotatable.
